(19) United States
(12) Patent Application Publication
(10) Pub. No.: US 2008/0147667 A1
(43) Pub. Date: Jun. 19, 2008

(54) DATA MANAGEMENT APPARATUS AND DATA MANAGEMENT METHOD THEREOF

(75) Inventors: Seung-ho Hur, Suwon-si (KR); Eun-sung Cho, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/954,496

(22) Filed: Dec. 12, 2007

(30) Foreign Application Priority Data
Dec. 15, 2006 (KR) 2006-128577

(51) Int. Cl. G06F 17/30

(52) U.S. Cl. 707/9; 707/E17.005

(57) ABSTRACT

A data management apparatus and a data management method thereof, the data management method includes: storing data in a first storage space of a storage unit, the first storage space corresponding to a first file system and a second storage space corresponding to a second file system different from the first file system; receiving an input for access to the first storage space; determining whether an access requester has access authority corresponding to the first file system; and processing the stored data based on the first file system if the access requester has the access authority. Accordingly, security of data is ensured.

### CROSS-REFERENCE TO RELATED APPLICATION

This application claims the benefit of Korean Application No. 2006-128577, filed Dec. 15, 2006, in the Korean Intellectual Property Office, the disclosure of which is incorporated herein by reference.

### BACKGROUND OF THE INVENTION

1. Field of the Invention

Aspects of the present invention relate to a data management apparatus and a data management method thereof, and more particularly, to a data management apparatus for managing data according to different file systems, and a data management method thereof.

2. Description of the Related Art

Data management apparatuses are connected to a host device in order to store and process data. Among them, an image forming apparatus having a storage medium stores print data in the storage medium, and forms an image on the basis of the stored print data. Here, each user assigns a password or the like for a file or folder that stores the print data so that other users are prevented from accessing the stored data. If a user wishes to access the data, the user must confirm the password to obtain an access authority.

However, in such a case where the access authority is confirmed through a password, an unauthorized use of the password may occur. As a result, forgery or falsification of data to be printed may occur, and security in the data management apparatus is compromised.

In addition, because the storage medium is connectable to an external host device when the storage medium is disconnected from the image forming apparatus, the print data may be easily extracted or exposed.

### SUMMARY OF THE INVENTION

Aspects of the present invention provide a data management apparatus that generates a file system corresponding to at least one storage space and manages data according to the generated file system in order to safely protect data stored in the storage unit, and a data management method thereof.

According to an aspect of the present invention, there is provided a data management method for a storage unit having a first storage space and a second storage space, the data management method including: storing data in the first storage space based on a first file system corresponding to the first storage space; receiving an input for access to the first storage space; determining whether an access requester has an access authority corresponding to the first file system; and processing the stored data based on the first file system if the access requester has the access authority, wherein the first file system corresponds to the first storage space and a second file system different from the first file system corresponds to the second storage space.

The method may further include storing common information, which allows an operating system of the data management apparatus to recognize the file systems corresponding to the storage spaces, in a common storage space among the storage spaces of the storage unit.

The access may be input from an external storage medium and/or a host device.

The external storage medium may be a memory card, a memory stick, or a smart card.

The data management method may further include communicating the data between the host device and the first storage space corresponding to the first file system if the host device has the access authority.

The data management method may further include displaying the data stored in the storage space.

According to another aspect of the present invention, there is provided a data management apparatus including: a storage unit which includes a first storage space corresponding to a first file system and a second storage space corresponding to a second file system; and a controller to store data in the first storage space based on the first file system, to receive an input for access to the first storage space, to determine whether an access requester has an access authority corresponding to the first file system, and to process the stored data based on the first file system corresponding to access authority if the access requester has the access authority corresponding to the file system.

The controller may store information for recognizing the file systems corresponding to the storage spaces in a common storage space among the storage spaces of the storage unit.

The data management apparatus may further include an interface unit to which an external storage medium and/or a host device connect, wherein the input is received from the external storage medium and/or the host device.

The external storage medium may be a memory card, a memory stick, or a smart card.

The controller may communicate the data between the host device and the storage space corresponding to the file system if the host device has the access authority.

The data management apparatus may further include a display part to display the data stored in the storage space.

According to another aspect of the present invention, there is provided a data management method for a data management apparatus including a storage unit, the data management method including: creating an access authority to at least one storage space of the storage unit; and creating at least one file system corresponding to the storage space.

The creating the file system may include: receiving an input for a creation of a new storage space; and creating the new storage space and a file system corresponding to the new storage space.

According to yet another aspect of the present invention, there is provided a data management apparatus including: a storage unit which includes at least one storage space; and a controller to create an access authority to the storage space and to create at least one file system corresponding to the storage space.

The controller may create a new storage space if there is an input for a creation of the new storage space, and may create a file system corresponding to the new storage space.

According to still another aspect of the present invention, there is provided an image forming apparatus including: a storage unit including a first storage space corresponding to a first file system and a second storage space corresponding to a second file system different from the first file system; and a controller to store data in the first storage space based on the first file system, and to store data in the second storage space based on the second file system.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a data management apparatus according to an embodiment of the present invention;

FIG. 2 is a block diagram illustrating a data management apparatus according to another embodiment of the present invention;

FIG. 3 is a diagram illustrating a storage unit in the data management apparatus according to an embodiment of the present invention;

FIG. 4 is a flowchart explaining a data management method for a data management apparatus according to an embodiment of the present invention; and

FIG. 5 is a flowchart explaining a data management method for a data management apparatus according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

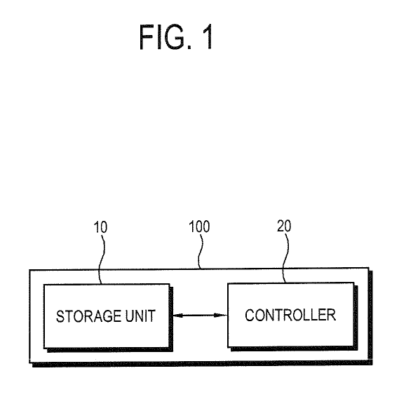

A data management apparatus 100 according to an embodiment of the present invention will now be described with reference to FIG. 1. FIG. 1 is a block diagram illustrating a configuration of a data management apparatus 100 according to an embodiment of the present invention. Referring to FIG. 1, the data management apparatus 100 includes a storage unit 10 and a controller 40. Furthermore, the data management apparatus 100 may be integrated into a printing device that forms an image based on print data. However, it is understood that aspects of the present invention are not limited thereto, and the data management apparatus may also be separate from a printing device and implemented on other data processing devices. Nonetheless, if the data management apparatus 100 is included in a printing apparatus, the data management apparatus 100 further includes a printing unit (not shown).

The storage unit 10 has one or more storage spaces that correspond to at least one file system. Furthermore, the storage unit 10 may be a volatile memory (such as RAM) or a non-volatile memory (such as ROM, flash memory, or a hard disk drive). Here, the file system is a system used to store data in the storage unit 10. Specifically, the file system determines a file name of data being stored in the storage unit 10, a position where the data is stored, a structure of a directory where the data is stored, etc. Therefore, even if a user wishes to access data stored in the storage unit 10 according to the file system, the user cannot access data stored in the storage unit 10 based on a different file system. According to an aspect of the present invention, the file system may be independent of those used in a commercial operating system. However, it is understood that aspects of the present invention are not limited thereto. Furthermore, the storage unit 10 may separately include a space for commonly storing file-system information on at least one storage space.

The controller 40 stores data in a storage space of the storage unit 10 depending on the corresponding file system, and processes the data stored therein if a user has the access authority for the corresponding file system to access the storage space.

In this regard, the controller 40 creates an access authority for at least one storage space of the storage unit 10, and creates at least one file system corresponding to the at least one storage space. For example, the access authority may be based on an identification, a password, etc. of a user. Accordingly, the storage unit 10 may have different storage spaces for a plurality of file systems according to different users. Further, the controller 40 may create a new storage space in the storage unit 10 and create a file system corresponding to the created storage space if the controller receives an input for the creation of the new storage space. According to another aspect of the present invention, the controller creates a new storage space in the storage unit 10 and creates a corresponding file system if the controller receives an input for a new user.

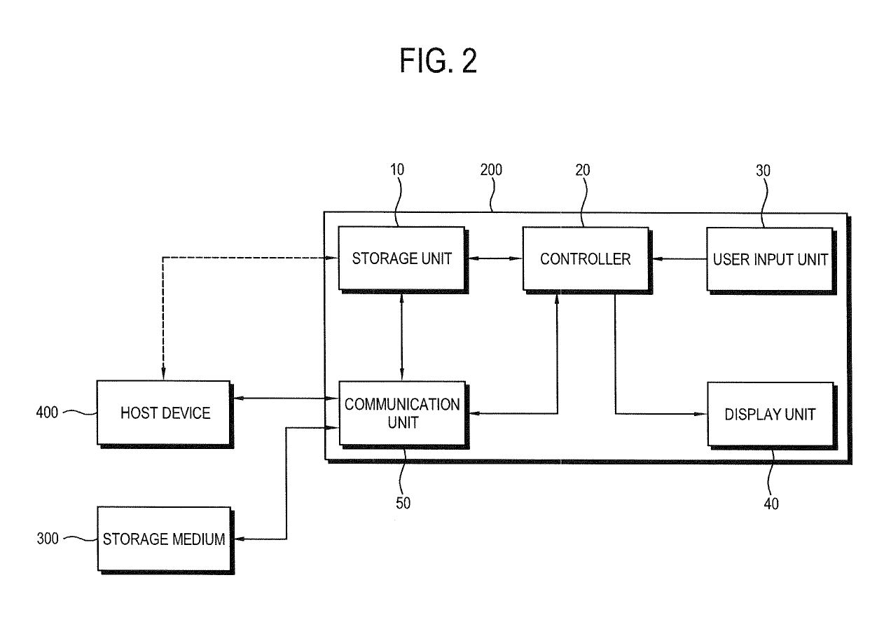

FIG. 2 is a block diagram illustrating a data management apparatus 200 according to another embodiment of the present invention. Referring to FIG. 2, the data management apparatus 200 includes a storage unit 10, a user input unit 20, a display unit 30, a controller 40, and a communication unit 50.

The user input unit 20 receives a user input for access to a storage space of the storage unit 10. Here, the user input unit 20 may receive a target storage space and an access authority to access the target storage space. The target storage space is a storage space to be accessed from among the storage spaces of the storage unit 10. Furthermore, the user input unit 20 may be provided at one side of a main body of the data management apparatus 200. However, it is understood that aspects of the present invention are not limited thereto. For example, the user input unit 20 may be provided in an external host device 400 other than the data management apparatus 200.

The display unit 30 displays data, which is stored based on the file system corresponding to an access authority, from at least one storage space of the storage unit 10 when the access authority is input from the user input unit 20 under the control of the controller 40. The display unit 30 may be a light emitting diode (LED) device, a liquid crystal display (LCD) panel, or other known display panels in the art.

The controller 40 stores the data in a storage space depending on the corresponding file system, and processes the data stored therein if a user has the access authority for the corresponding file system to access the storage space. The controller 20 may include an operating system having information related to the respective file systems corresponding to the plurality of storage spaces included in the storage unit 10. Furthermore, when the controller 40 receives an input for the creation of a new storage space in the storage unit 10 from the user input unit 20, the controller 40 creates the new storage space according to a new file system to then allow for an access authority for data stored in the created storage space.

Specifically, the controller 40 creates or designates a storage space that is not allocated to a user from among the storage spaces of the storage unit 10 according to a new file system differing from the existing file systems. The controller 40 creates the storage space when the number of the users becomes larger than the number of storage spaces allocated to users upon a new user's access request. New access authority may be given so that only a corresponding user can access the newly created storage space.

The controller 40 may establish, in advance, a size of the storage space in the storage unit 10 according to a maximum number of file systems that can exist at the time of creating storage spaces according to the respective file systems. In addition, if the controller 40 receives an input for migration of data stored in a storage space from the user input unit 20, the controller 40 controls the data to be stored according to the file system of the storage space to where the data migrates. That is, the controller 40 reads a file name of data to be migrated, a position where the data is stored, a structure of a directory where the data is stored, etc., from the corresponding file system of the storage space where the data to be migrated is stored. Then, the controller 40 controls the data to be stored according to the file system of the storage space where the data is to be stored.

The communication unit 50 receives information related to an access authority from an external storage medium 300. The external storage medium 300 may be any general storage medium (such as a memory card, a memory stick, etc.) that can store information about the access authority. For example, the external storage medium 300 may be implemented in a smart card. Here, the smart card may be either a contact type or a contactless type. According to an aspect of the present invention, the communication unit 50 may be a universal serial bus (USB) port, a parallel port, etc., to which the external storage medium 300 and the host device 400 may be connected. However, it is understood that aspects of the present invention are not limited thereto, and the communication unit 50 may be any port or device to which a storage medium and/or an external device may be connected.

According to an aspect of the present invention, the storage unit 10 may be separated from the data management apparatus 200 and connected to the external host device 400. Here, the external host device 400 may be a personal computer, a mobile phone, a personal digital assistant (PDA), etc., and can be interconnected with the storage unit 10. Furthermore, the external host device 400 may also connect to the storage unit 10 through the communication unit 50.

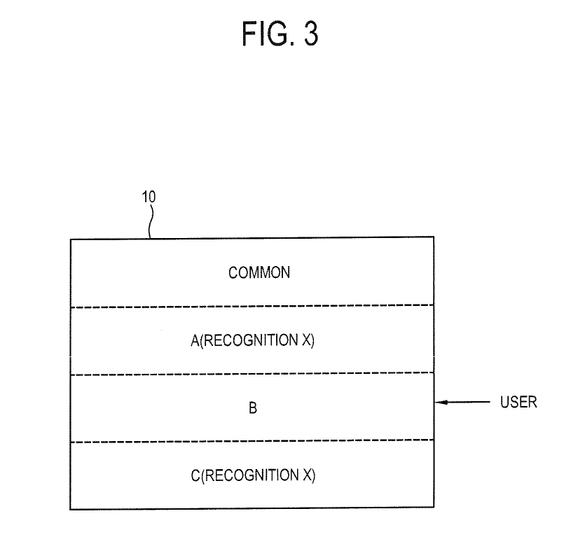

FIG. 3 is a diagram illustrating a storage unit 10 in the data management apparatus 100 or 200 according to an embodiment of the present invention. Referring to FIG. 3, the storage unit 10 includes storage spaces according to three file systems. However, it is understood that aspects of the present invention are not limited thereto, and more than three storage spaces and three file systems may be implemented in the storage unit 10.

The storage unit 10 includes a space (“COMMON”) to commonly store file system information related to a plurality of storage spaces. Furthermore, the storage unit 10 includes storage spaces A, B and C corresponding to each file system. Here, if a user has an access authority for only the storage space B, data stored in the storage spaces A and C according to other file systems differing from the file system of the storage space B will not be recognized. Accordingly, data stored in the storage unit 10 is safely protected.

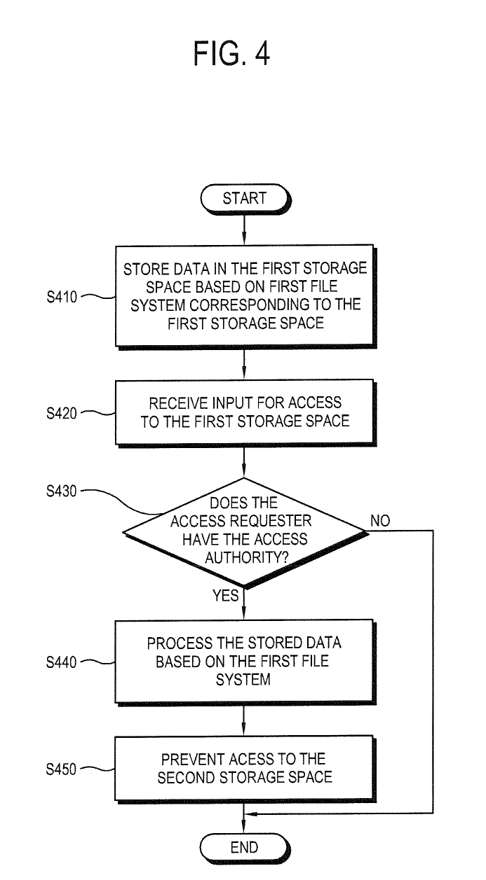

Hereinafter, a data management method for a data management apparatus 100 or 200 according to an embodiment of the present invention will be described with reference to FIG. 4. Referring to FIG. 4, the controller 40 stores data (such as print data) in at least one storage space corresponding to at least one file system in a storage unit 10 in operation S410. In addition, the controller 40 receives a user input for access to the storage space of the storage unit 10 in operation S420. Here, the controller 40 may also receive an input for a creation of a new storage space in the storage unit 10, and may create a new storage space according to a new file system to then allow for an access authority to data stored in the newly created storage space. Furthermore, the controller 20 may receive an input for access from an external storage medium 300 in operation S420.

After receiving the input for access to the data stored in the storage space (operation S420), the controller 40 determines whether access authority corresponding to the storage space exists in operation S430. Thus, if the controller 40 determines that the access authority exists (operation S430), the controller 40 processes stored data according to the file system of the storage space corresponding to the access authority in operation S440.

According to an aspect of the present invention, the controller 40 may also receive an input for migration of data stored in the storage space. In this case, the controller receives the input for migration of data in operation S420, and the data can be stored and processed according to the file system of the storage space to where the data migrates.

In addition, the controller 40 may further perform operations of transferring or processing data between the external host device 400 and the storage space (i.e., storing data of the external host device 400 in the storage space of the storage unit 10) according to the access authority, and transmitting data stored in the storage space of the storage unit 10 to the external host device 400.

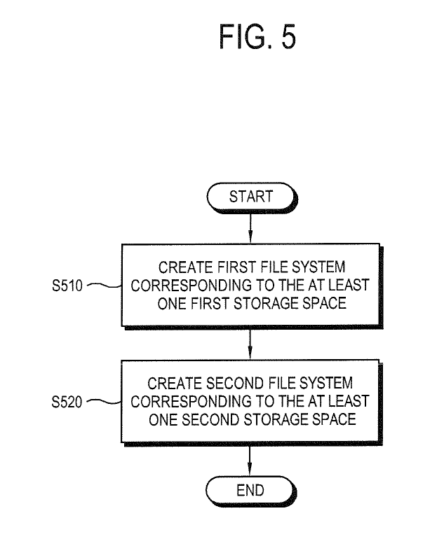

FIG. 5 is a flowchart explaining a data management method for a data management apparatus according to another embodiment of the present invention. Referring to FIG. 5 the controller 20 creates an access authority to at least one storage space of the storage unit 10 in operation S510. Furthermore, the controller 20 creates at least one file system corresponding to the storage space of the storage unit 10 in operation S520. Accordingly, the storage unit 10 may have different storage spaces for different file systems that are accessible by different users. If there is an input for a creation of a new storage space in operation S510, the controller 20 may create a new storage space and a file system corresponding to the new storage space.

As described above, aspects of the present invention provide a data management apparatus 100 or 200 that creates a file system corresponding to at least one storage space and manages data according to the created file systems, and a data management method thereof.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A data management method for a storage unit having a first storage space and a second storage space different from the first storage space, the data management method comprising:
storing data in the first storage space based on a first file system corresponding to the first storage space;
receiving an input for access to the first storage space;
determining whether an access requester has an access authority corresponding to the first file system;
processing the stored data based on the first file system if the access requester has the access authority; and
preventing access, by the access requester, to the second storage space,
wherein the first file system corresponds to the first storage space, and a second file system different from the first file system corresponds to the second storage space such that a file directory of the second storage space does not include the data stored in the first storage space.

2. The data management method as claimed in claim 1, further comprising:
storing common information in a third storage space of the storage unit, different from the first and second storage spaces,
wherein the common information allows an operating system of a data management apparatus including the storage unit to recognize the first file system and the second file system.

3. The data management method as claimed in claim 1, wherein the input is received from an external storage medium and/or a host device.

4. The data management method as claimed in claim 1, further comprising transferring the data between a host device and the first storage space corresponding to the file system if the host device has the access authority.

5. The data management method as claimed in claim 1, further comprising displaying the data stored in the first storage space.

6. The data management method as claimed in claim 1, wherein the storage unit is comprised in an image forming apparatus, and the data is print data to be printed by the image forming apparatus.

7. The data management method as claimed in claim 1, wherein the preventing of the access, by the access requester, to the second storage space comprises:
receiving an input for access to the second storage space;
determining whether the access requester has an access authority corresponding to the second file system, different from the access authority corresponding to the first file system;
allowing the access to the second file system by the access requester if the access requester has the access authority corresponding to the second file system; and
preventing the access to the second file system by the access requester if the access requester does not have the access authority corresponding to the second file system.

8. The data management method as claimed in claim 1, further comprising:
receiving a request of a new access;
allocating an unused storage space in the storage unit according to a new file system, different from the first and second file systems, to the new access; and
allocating, to the new access, a new access authority controlling an access to the new storage space.

9. A data management apparatus comprising:
a storage unit comprising a first storage space corresponding to a first file system and a second storage space, different from the first storage space, corresponding to a second file system different from the first file system such that a file directory of the second storage space does not include data stored in the first storage space; and
a controller to store data in the first storage space based on the first file system, to receive an input for access to the first storage space-, to determine whether an access requester has an access authority corresponding to the first file system, to process the stored data based on the first file system if the access requester has the access authority corresponding to the first file system, and to prevent access, by the access requester, to the second storage space.

10. The data management apparatus as claimed in claim 9, wherein:
the storage unit further comprises a third storage space, different from the first and second storage spaces; and
the controller stores, in the third storage space, common information for recognizing the first file system and the second file system.

11. The data management apparatus as claimed in claim 9, further comprising an interface unit through which an external storage medium and/or a host device connect to the data management apparatus,
wherein the input is received from the external storage medium and/or the host device.

12. The data management apparatus as claimed in claim 9, wherein the controller transfers the data between a host device and the first storage space corresponding to the first file system if the host device has the access authority.

13. The data management apparatus as claimed in claim 9, further comprising a display unit to display the data stored in the first storage space.

14. A data management method for a data management apparatus including a storage unit, the data management method comprising:
creating a first access authority controlling an access to at least one first storage space of the storage unit;
creating a second access authority, different from the first access authority, controlling an access to at least one second storage space of the storage unit, different from the at least one first storage space;
creating a first file system corresponding to the at least one first storage space; and
creating a second file system, different from the first file system, corresponding to the at least one second storage space such that a file directory of the second storage space does not include data stored in the first storage space.

15. The data management method as claimed in claim 14, further comprising:
receiving an input for creation of a new storage space; and
creating the new storage space and creating a new file system corresponding to the new storage space.

16. The data management method as claimed in claim 14, further comprising:
creating a new access authority, different from the first and second access authorities, controlling an access to the new storage space.

17. The data management method as claimed in claim 14, wherein the data management apparatus is an image forming apparatus.

18. A data management apparatus comprising:
a storage unit comprising at least one first storage space and at least one second storage space, different from the at least one first storage space; and
a controller to create a first access authority controlling an access to the at least one first storage space, to create a second access authority controlling an access to the at least one second storage space, to create a first file system corresponding to the at least one first storage space, and to create a second file system, different from the first file system, corresponding to the at least one second storage space such that a file directory of the second storage space does not include data stored in the first storage space.

19. The data management apparatus as claimed in claim 18, wherein the controller creates a new storage space if the controller receives an input for creation of the new storage space, and creates a new file system corresponding to the new storage space.

20. The data management apparatus as claimed in claim 18, wherein the controller creates a new access authority, different from the first and second access authorities, controlling an access to the new storage space.

21. An image forming apparatus comprising:
a storage unit comprising a first storage space corresponding to a first file system and a second storage space corresponding to a second file system different from the first file system such that a file directory of the second storage space does not include data stored in the first storage space; and
a controller to store data in the first storage space based on the first file system, and to store data in the second storage space based on the second file system.

22. The apparatus as claimed in claim 21, wherein if the controller receives an input for access to the first storage space, the controller determines whether an access requester has an access authority corresponding to the first file system, processes the stored data based on the first file system if the access requester has the access authority corresponding to the first file system, and prevents access by the access requester to the second storage space.

23. The apparatus as claimed in claim 22, further comprising an interface unit through which an external storage medium and/or a host device connect to the data management apparatus,
wherein the input is received from the external storage medium and/or the host device.

24. The apparatus as claimed in claim 22, wherein the controller transfers the data between a host device and the first storage space corresponding to the first file system if the host device has the access authority.

25. The apparatus as claimed in claim 22, further comprising a print unit to print the stored data if the access requester has an access authority corresponding to the first file system.
